(19) United States
(12) Patent Application Publication
(10) Pub. No.: US 2025/0096342 A1
(43) Pub. Date: Mar. 20, 2025

(54) BATTERY AND ELECTRICAL DEVICE

(71) Applicant: Ningde Amperex Technology Limited, Ningde (CN)

(72) Inventors: Denglong HUANG, Ningde (CN); Yanchen TONG, Ningde (CN); Shenbo WANG, Ningde (CN); Chao JIANG, Ningde (CN)

(73) Assignee: Ningde Amperex Technology Limited, Ningde (CN)

(21) Appl. No.: 18/963,969

(22) Filed: Nov. 29, 2024

Related U.S. Application Data
(63) Continuation of application No. PCT/CN2022/096422, filed on May 31, 2022.

(51) Int. Cl. H01M 10/48; H01M 50/211; H01M 50/244; H01M 50/284

(52) U.S. Cl. CPC H01M 10/486; H01M 50/211; H01M 50/244; H01M 50/284

(57) ABSTRACT

A battery includes a first battery cell and a second battery cell, a buffer member, and a temperature collection member provided in a stacked manner; the buffer member is provided between the first battery cell and the second battery cell and/or is provided on a side of the first battery cell away from the second battery cell; the temperature collection member is provided between the first battery cell and the buffer member for collecting a temperature of the first battery cell; the temperature collection member is of a sheet structure, and a thickness direction of the temperature collection member is parallel to a stacking direction of the first battery cell and the second battery cell.

### CROSS-REFERENCE TO RELATED APPLICATION

The present application is a continuation application of PCT Application Serial Number PCT/CN2022/096422, filed on May 31, 2022, the content of which is incorporated herein by reference in its entirety.

### TECHNICAL FIELD

This application relates to the technical field of batteries, and in particular, to a battery and an electrical device.

### BACKGROUND

By virtue of outstanding advantages such as a high energy density and high cycle performance, secondary batteries are widely used in many fields such as portable electronic devices, electric transportation, electric tools, drones, and energy storage devices.

Whether the safety of a battery meets needs of use is a widely researched topic at present. The internal temperature of the battery is one of the important factors affecting the safety performance of the battery, and it is necessary to obtain the accurate temperature information inside the battery to better ensure the safety performance of the battery. Therefore, how to improve the accuracy of the internal temperature detection of the battery has become an urgent problem in the field of battery technology.

### SUMMARY

Embodiments of this application provide a battery and an electrical device to improve the accuracy of internal temperature detection of a battery.

According to a first aspect, embodiments of this application provide a battery including a first battery cell and a second battery cell provided in a stacked manner, a buffer member, and a temperature collection member; the buffer member is provided between the first battery cell and the second battery cell and/or is provided on a side of the first battery cell facing away from the second battery cell; the temperature collection member is provided between the first battery cell and the buffer member for collecting a temperature of the first battery cell; where the temperature collection member has a sheet structure, and a thickness direction of the temperature collection member is parallel to a stacking direction of the first battery cell and the second battery cell.

In the above technical solution, the temperature collection member has the sheet structure and is provided between the first battery cell and the buffer member, which can reduce the occupied space between the first battery cell and the buffer member, reduce the impact on the expansion space of the first battery cell, thereby reducing the amount of loss of the expansion space of the first battery cell due to the temperature collection member, thereby reducing the risk of the surface of the first battery cell breaking and leaking liquid and the risk of causing a short circuit inside the battery in the process of use, and also reducing the impact on the energy density of the battery. The temperature collection member having the sheet structure can also accurately characterize the temperature of the battery, and improve the reliability of temperature detection. At the same time, the response speed of the temperature collection member having the sheet structure is faster than the response speed of a temperature collection member having a teardrop-shape. Under high rate conditions, the temperature collection member having the sheet structure can quickly respond to the rise in the temperature of the battery, and improve the reliability of the use of the battery.

In some embodiments of the first aspect of this application, the buffer member is provided with an accommodation cavity corresponding to the position of the temperature collection member.

In the above technical solution, the temperature collection member is disposed corresponding to the accommodation cavity, so that after the first battery cell expands, the temperature collection member can partially enter the accommodation cavity, and the accommodation cavity provides a clearance space for the temperature collection member to avoid the temperature collection member and the buffer member from being extruded, so as to reduce the risk of the temperature collection member being extruded and damaged due to the expansion of the first battery cell.

In some embodiments of the first aspect of this application, the temperature collection member includes a body and two protrusions. Two protrusions are formed on two surfaces of the body opposite each other along the stacking direction. Along the stacking direction, among two protrusions, one protrusion closer to the buffer member has a projection on the buffer member located in the accommodation cavity.

In the above technical solution, the two protrusions respectively form two surfaces of the body opposite to each other along the stacking direction. The dimension of the temperature collection member at the corresponding position of the protrusion along the stacking direction is larger than the dimension of the temperature collection member at other positions. When the first battery cell expands, the protrusion closer to the first battery cell is the first to be extruded, the protrusion closer to the buffer member has the projection on the buffer member located in the accommodation cavity, and the protrusion closer to the buffer member can be inserted into the accommodation cavity when the first battery cell expands, avoiding the protrusion closer to the buffer member and the buffer member from being extruded, which reduces the risk of the temperature collection member being extruded and damaged.

In some embodiments of the first aspect of this application, the battery further includes: a mounting plate, provided between the first battery cell and the buffer member. The mounting plate has a mounting groove, the mounting groove penetrates through the mounting plate along a thickness direction of the mounting plate, the thickness direction of the mounting plate is parallel to the stacking direction, and the temperature collection member being provided in the mounting groove.

In the above technical solution, the mounting plate is provided to facilitate the installation of the temperature collection member, and the temperature collection member is installed in the mounting groove of the mounting plate. The mounting groove provides a clearance space for the temperature collection member to avoid the temperature collection member and the mounting plate from occupying too much space between the first battery cell and the buffer member, and to reduce the impact on the energy density of the battery.

In some embodiments of the first aspect of this application, the mounting groove forms a first opening at an edge of the mounting plate, the temperature collection member can be inserted into the mounting groove through the first opening.

In the above technical solution, the mounting groove is provided with a first opening, and the temperature collection member can be inserted into the mounting groove from the first opening, facilitating the installation of the temperature collection member into the mounting groove.

In some embodiments of the first aspect of this application, the mounting groove is provided with a guiding bevel at an end of the mounting groove closer to the first opening, and the guiding bevel is used to guide the temperature collection member to be inserted into the mounting groove.

In the above technical solution, the guiding bevel is provided at the end of the mounting groove closer to the first opening to enable the mounting groove to form a larger inlet in the edge of the mounting plate, so that the temperature collection member can be smoothly mounted into the mounting groove.

In some embodiments of the first aspect of this application, a hardness of the mounting plate is greater than a hardness of the buffer member.

In the above technical solution, the hardness of the mounting plate is greater than the hardness of the buffer member, which can not only provide a stable support for the temperature collection member mounted on the mounting plate, but also reduce the degree of compression of the mounting plate when the first battery cell expands or avoid the mounting plate from being compressed when the first battery cell expands.

In some embodiments of the first aspect of this application, the mounting plate is made of an insulating material.

In the above technical solution, the mounting plate is made of an insulating material, which can reduce the risk of short circuit inside the battery.

In some embodiments of the first aspect of this application, the mounting plate is provided with a first through hole, along the stacking direction, the first through hole penetrating through the mounting plate.

In the above technical solution, the first through hole is provided in the mounting plate, which can avoid the central expansion region of the first battery cell, avoid the loss of the expansion space of the first battery cell due to the provision of the mounting plate, and effectively reduce the risk of the surface of the first battery cell breaking and leaking liquid caused by the mounting plate interfering with the expansion of the first battery cell.

In some embodiments of the first aspect of this application, the buffer member is provided with a second through hole, along the stacking direction, the second through hole penetrates through the buffer member, and a projection of the first through hole on the buffer member at least partially overlaps the second through hole.

In the above technical solution, the second through hole is provided in the buffer member, and the projection of the first through hole of the mounting plate on the buffer member at least partially overlaps the second through hole, which can avoid the central expansion region of the first battery cell, avoid the loss of the expansion space of the first battery cell due to the provision of the mounting plate and the buffer member, and effectively reduce the risk of the surface of the first battery cell breaking and leaking liquid caused by the mounting plate and the buffer member interfering with the expansion of the first battery cell.

In some embodiments of the first aspect of this application, the temperature collection member has a maximum thickness of h1 and the mounting plate has a thickness of h2, satisfying: h2<h1.

In the above technical solution, the maximum thickness of the temperature collection member is greater than the thickness of the mounting plate, so that after the temperature collection member is mounted in the mounting groove, the temperature collection member can extend out of the mounting groove along the stacking direction to enable the temperature collection member to be in contact with the first battery cell, so as to make the collected temperature information more accurate.

In some embodiments of the first aspect of this application, the temperature collection member has a maximum thickness of h1, the mounting plate has a thickness of h2, and the buffer member compressed to a limit has a thickness of h3, satisfying: h2+h3≥ h1.

In the above technical solution, the sum of the thickness of the mounting plate and the thickness of the buffer member compressed to the limit is greater than or equal to the maximum thickness of the temperature collection member, so that even when the buffer member is compressed to the limit state, the temperature collection member is not be extruded, and the risk of the temperature collection member being extruded and damaged is reduced.

In some embodiments of the first aspect of this application, the battery further includes: a film, provided between the mounting plate and the buffer member, the film at least partially covering the temperature collection member.

In the above technical solution, the film is provided between the buffer member and the mounting plate and at least partially covers the temperature collection member, so that the temperature collection member always remains in contact with the first battery cell, which is conducive to the temperature collection member to obtain accurate temperature information.

In some embodiments of the first aspect of this application, the film is bonded or heat fused to the mounting plate.

In the above technical solution, the connection of the film and the mounting plate is realized by means of bonding or heat fusion, which is convenient and does not increase the thickness of the overall structure after the film and the mounting plate are connected.

In some embodiments of the first aspect of this application, the battery further includes: a circuit board and a wire. The circuit board is provided on a side of the first battery cell and the second battery cell along a first direction, the first direction is perpendicular to the stacking direction; one end of the wire is connected to the temperature collection member and the other end of the wire is connected to a side of the circuit board facing away from the first battery cell and the second battery cell, where the circuit board is provided with a channel, the channel penetrates through the circuit board along a thickness direction of the circuit board, and the channel is configured for passage of the wire.

In the above technical solution, the circuit board is provided with a channel for the wire to pass through, the wire serves as a soldered jumper wire, and the wire passes through the channel and are connected to a side of the circuit board facing away from the first battery cell and the second battery cell, so as to avoid damage to the phosphorus-copper frame of the temperature collection member having the sheet structure caused by the bending of the temperature collection member in the assembling process, and to reduce the extension path of the wire and the length of the wire, thereby reducing the occupied internal space of the battery by the wire.

In some embodiments of the first aspect of this application, the projection of the temperature collection member on the circuit board at least partially overlaps the channel along a thickness direction of the circuit board.

In the above technical solution, the projection of the temperature collection member on the circuit board at least partially overlaps the channel, so that the temperature collection member can be inserted between the first battery cell and the buffer member from the channel position, facilitating the installation of the temperature collection member.

In some embodiments of the first aspect of this application, the first battery cell includes a battery cell body and a tab extending from an end portion of the battery cell body, and the temperature collection member is provided at the end portion.

In the above technical solution, the temperature collection member is provided at the end portion, and the temperature collection member is provided closer to the tab, which not only enables the temperature collection member to be provided in a region corresponding to a region where the expansion amount of the first battery cell is smaller, reduces the risk of the temperature collection member being extruded and damaged, but also enables the temperature collection member to collect more accurate temperature information.

According to a second aspect, embodiments of this application provide an electrical device, including the battery disclosed in the embodiments of the first aspect.

In the above technical solution, the temperature collection member of the battery of the embodiments of the first aspect has a sheet structure, and is provided between the first battery cell and the buffer member, which can reduce the occupied space between the first battery cell and the buffer member, and reduce the impact on the energy density of the battery. The temperature collection member having the sheet structure can also accurately characterize the temperature of the battery, and improve the reliability of temperature detection. At the same time, the response speed of the temperature collection member having the sheet-like structure is faster than the response speed of a temperature collection member having a teardrop-shape. Under high rate conditions, the temperature collection member having the sheet structure can quickly respond to the temperature rise of the battery, improving the reliability of the use of the battery of the electrical device.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope.

FIG. 1 is a schematic structural diagram of a battery according to some embodiments of this application;

FIG. 2 is a schematic structural diagram of a battery according to some other embodiments of this application;

FIG. 3 is a schematic structural diagram of a battery according to still other embodiments of this application;

FIG. 4 is an enlarged view of A in FIG. 3;

FIG. 5 is a schematic structural diagram of a buffer member according to some embodiments of this application;

FIG. 6 is a schematic structural diagram of a buffer member according to some other embodiments of this application;

FIG. 7 is a schematic diagram of the relative relationship between the temperature collection member and the buffer member according to some embodiments of this application;

FIG. 8 is a close-up view of B shown in FIG. 7;

FIG. 9 is a schematic diagram of the buffer member compressed after expansion of the first battery cell and the protrusion facing the buffer member is inserted into the through hole;

FIG. 10 is a schematic diagram of the relative relationship of the temperature collection member and the buffer member according to some other embodiments of this application;

FIG. 11 is a schematic structural diagram of the mounting plate according to some embodiments of this application;

FIG. 12 is a schematic structural diagram of the mounting plate according to some other embodiments of this application;

FIG. 13 is a close-up view at C shown in FIG. 12;

FIG. 14 is a schematic diagram of the relative relationship of the mounting plate, the buffer member and the film;

FIG. 15 is a cross-sectional view of the temperature collection member after the temperature collection member is inserted in the mounting groove of the mounting plate;

FIG. 16 is a cross-sectional view of the temperature collection member, the mounting plate and the buffer member compressed to the limit;

FIG. 17 is a schematic structural diagram of the battery according to some further embodiments of this application;

FIG. 18 is a close-up view at D shown in FIG. 17;

FIG. 19 is an exploded view of a battery according to some other embodiment of this application;

FIG. 20 is a schematic structural diagram of a battery according to still some other embodiment of this application; and

FIG. 21 is a close-up view at E shown in 20.

Reference numerals: 100—battery; 10—first battery cell; 11—battery cell body; 111—end portion; 12—tab; 20—second battery cell; 30—buffer member; 31—accommodation cavity; 32—second opening; 33—second through hole; 40—temperature collection member; 41—body; 411—first surface; 412—second surface; 42—protrusions; 43—wire; 50—box; 60—mounting plate; 61—mounting groove; 611—groove wall; 6111—flat surface; 6112—guiding bevel; 62—first opening; 63—first through hole; 70—film; 71—third through hole; 80—circuit board; 81—channel; 82—third opening; X—stacking direction.

### DETAILED DESCRIPTION

To make the objectives, technical solutions, and advantages of embodiments of this application clearer, the following gives a clear and complete description of the technical solutions in embodiments of this application with reference to the drawings in some embodiments of this application. Apparently, the described embodiments are merely a part of but not all of the embodiments of this application. The components of embodiments of this application generally described and illustrated in the accompanying drawings herein may be arranged and designed in a variety of different configurations.

Therefore, the following detailed description of the embodiments of this application provided with reference to the drawings is not intended to limit the scope of this application as claimed, but merely represents selected embodiments of this application.

It needs to be noted that to the extent that no conflict occurs, the embodiments of this application and the features in the embodiments may be combined with each other.

It is hereby noted that similar reference numerals and letters indicate similar items in the following drawings. Therefore, once an item is defined in one drawing, the item does not need to be further defined or construed in subsequent drawings.

In the descriptions of embodiments of this application, it is hereby noted that indication of orientations or positional relationships is based on orientations or positional relationships shown in the accompanying drawings, or orientations or positional relationships in which the product of the application is customarily placed in use, or orientations or positional relationships customarily understood by a person skilled in the art, is intended only for the purpose of facilitating the descriptions of this application and to simplify the descriptions, and does not indicate or imply that the apparatus or element referred to must have a particular orientation or be constructed and operated in a particular orientation, and therefore is not to be construed as a limitation of this application. In addition, the terms “first”, “second”, “third”, and the like are used only for the purpose of differentiating descriptions and are not to be understood as indicating or implying relative importance.

The development of the battery technology needs to allow for a plurality of design factors, including performance parameters such as energy density, cycle life, discharge capacity, charge and discharge rate. In addition, it needs to allow for the safety of the battery. The internal temperature of the battery is one of the important factors affecting the safety performance of the battery, and it is necessary to obtain accurate information about the internal temperature of the battery to better ensure the safety performance of the battery.

The battery includes a plurality of battery cells provided in a stacked manner, and in order to obtain temperature information of the battery, a temperature collection member is provided on a side of the battery cell or between two adjacent battery cells, and the temperature collection member may be in contact with the battery cell.

When the temperature collection member provided between two battery cells is in a teardrop-shape, in combination with the structural shape of the temperature collection member having the teardrop-shape, no matter whether it is a pouch battery cell or a steel shell battery cell, placing the temperature collection member having the teardrop between adjacent battery cells result in loss of expansion space of the battery cell and the risk of the temperature collection member extruding to the battery cell, which may result in the surface of the battery cell being broken and leaking liquid, and may also result in a short circuit inside the battery in the process of using the battery. In addition, due to the resin coating on the exterior of the temperature collection member having the teardrop-shape, the temperature response speed is slow under conditions of rapid temperature rise at a high rate, and the real temperature of the battery cannot be accurately fed back.

Based on the above considerations, in order to alleviate the influence of the temperature collection member on the expansion control of the battery cell and to obtain an accurate temperature value of the battery, the applicant designs a battery. The battery includes a first battery cell and a second battery cell provided in a stacked manner, a buffer member, and a temperature collection member, the buffer member is provided between the first battery cell and the second battery cell and/or is provided on a side of the first battery cell facing away from the second battery cell; the temperature collection member is provided between the first battery cell and the second battery cell for collecting the temperature; the temperature collection member has a sheet structure.

The temperature collection member has a sheet structure and is provided between the first battery cell and the buffer member, which can reduce the occupied space between the first battery cell and the buffer member, reduce the impact on the expansion space of the first battery cell, thereby reducing the amount of loss of the expansion space of the first battery cell due to the temperature collection member, thereby reducing the risk of the surface of the first battery cell breaking and leaking liquid and the risk of causing a short circuit inside the battery in the process of use, and also reducing the impact on the energy density of the battery.

The temperature collection member having the sheet structure can also accurately characterize the temperature of the battery, and improve the reliability of temperature detection. At the same time, the response speed of the temperature collection member having the sheet structure is faster than the response speed of a temperature collection member having a teardrop-shape. Under high rate conditions, the temperature collection member having the sheet structure can quickly respond to the rise in the temperature of the battery, and improve the reliability of the use of the battery.

The battery packs disclosed in embodiments of this application may, but are not limited to, be used in electrical devices such as electric two-wheelers, electric tools, drones, energy storage devices, etc. Batteries having the working conditions of this application can be used as a power supply system of the electrical device, which is conducive to improving the charging and discharging safety of the power supply system and the power safety of the electrical device.

An embodiment of this application provides an electrical device using a battery as a power source, the electrical device may be, but is not limited to, an electronic device, an electric tool, an electric vehicle, a drone, and an energy storage device. Among them, the electronic device may include a cell phone, a tablet, a laptop computer, etc., the electric tool may include an electric drill, an electric saw, etc., and the electric vehicle may include an electric car, an electric motorcycle, an electric bicycle, etc.

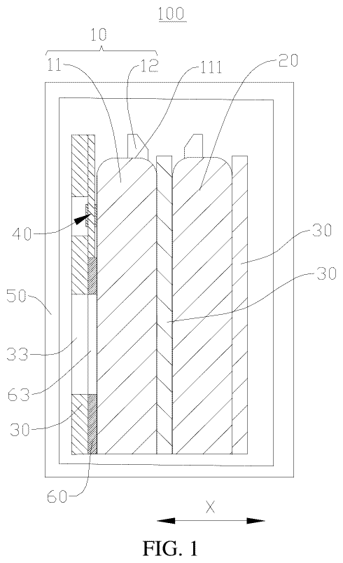

As shown in FIGS. 1, 2, 3, and 4, an embodiment of this application provides a battery 100, the battery 100 including a first battery cell 10 and a second battery cell 20 provided in a stacked manner, a buffer member 30, and a temperature collection member 40; the buffer member 30 is provided between the first battery cell 10 and the second battery cell 20 and/or on a side of the first battery cell 10 facing away from the second battery cell 20; the temperature collection member 40 is provided between the first battery cell 10 and the buffer member 30 for collecting a temperature of the first battery cell 10; where the temperature collection member 40 has a sheet structure, and a thickness direction of the temperature collection member 40 is parallel to a stacking direction X of the first battery cell 10 and the second battery cell 20.

In some embodiments, the battery 100 further includes a box 50, the box 50 being formed with an accommodation space. The first battery cell 10, the second battery cell 20, the buffer member 30, and the temperature collection member 40 are all accommodated within the accommodation space of the box 50.

The battery 100 includes a plurality of battery cells, plurality meaning two or more. In the battery 100, the plurality of battery cells may be connected in series or in parallel or series-and-parallel pattern, and the series-and-parallel pattern means a combination of series connection and parallel connection of the plurality of battery cells. The plurality of battery cells may be directly connected in series or in parallel or series-and-parallel pattern to form a battery cell module; of course, it is also possible that the plurality of battery cells is first connected in series or in parallel or series-and-parallel pattern to form a battery cell module.

Each battery cell may be a secondary battery, and the secondary battery includes a lithium-sulfur battery, a sodium-ion battery, a magnesium-ion battery, a solid state battery, and the like, but are not limited thereto. The battery cell may be presented in the form of a flat body, a rectangular body, or other shapes. The shell of the battery cell may be presented in the form of a hard shell, i.e., the battery cell is a hard-shell battery cell; the battery cell may also be presented in the form of pouch, i.e., the battery cell is a pouch battery cell.

As shown in FIG. 1, the battery 100 may include only a first battery cell 10 and a second battery cell 20, i.e., the battery 100 has only two battery cells, and in such an embodiment, the side of the first battery cell 10 that is back from the second battery cell 20 is a box wall of the box 50, and the side of the second battery cell 20 that is back from the first battery cell 10 is a box wall of the box 50. In this embodiment, the temperature collection member 40 may be provided between the first battery cell 10 and the buffer member 30 located between the first battery cell 10 and the box wall of the box 50. Of course, the temperature collection member 40 may also be provided between the first battery cell 10 and the buffer member 30 located between the first battery cell 10 and the second battery cell 20.

The buffer member 30 may include a foam, such as an ethylene-vinyl acetate copolymer (EVA) foam, a neoprene (CR) foam, and the like. The buffer member 30 may also include adhesive layers provided on both sides of the foam along the stacking direction X. Two adhesive layers are used to enable the buffer member 30 to be connected to the structure on each side thereof, for example, one adhesive layer connects the buffer member 30 to the second battery cell 20, and the other adhesive layer is used to connect the buffer member 30 to a mounting plate 60 or a film 70 (illustrated in FIG. 18). The adhesive layer may be a rigid adhesive layer, and only the foam is compressed when the buffer member 30 is extruded along the stacking direction X. The foam may be compressed up to a limit of 70%, i.e., the foam has an initial thickness of M. After the foam is compressed to the limit, the foam has a limit thickness of 0.3M.

The number of buffer members 30 may be one or a plurality. In embodiments where the number of buffer members 30 is one, the buffer member 30 may be provided between the first battery cell 10 and the second battery cell 20, or the buffer members 30 may be provided between the first battery cell 10 and a box wall of the box 50, or the buffer members 30 may also be provided between the second battery cell 20 and a box wall of the box 50. In embodiments where the number of buffer members 30 is more than one, the buffer members 30 may be provided between the first battery cell 10 and the second battery cell 20, between the first battery cell 10 and the box wall of the box 50, and between the second battery cell 20 and the box wall of the box 50.

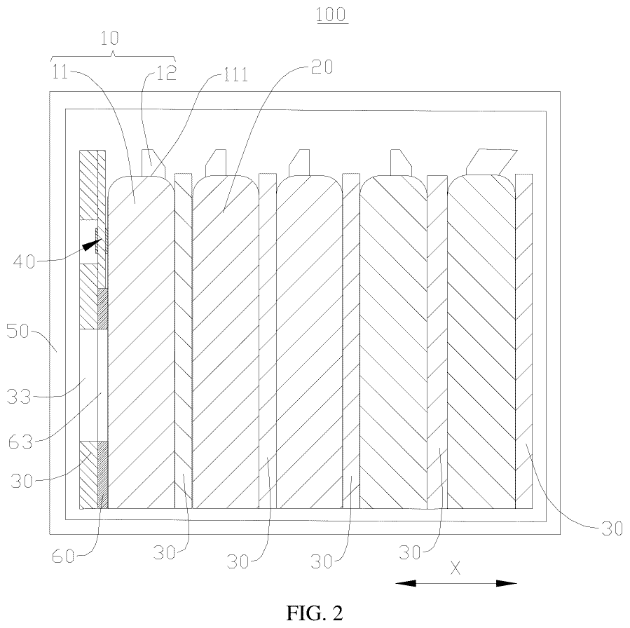

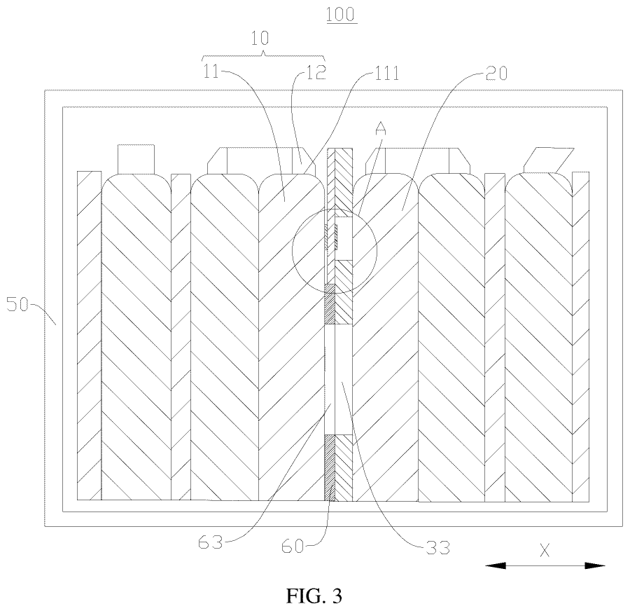

The battery 100 may also include three and more than three numbers of battery cells, and in such embodiments, a side of the first battery cell 10 facing away from the second battery cell 20 may be a battery cell or a box wall of the box 50. As shown in FIG. 2, the side of the first battery cell 10 facing away from the second battery cell 20 may be a box wall of the box 50, and the temperature collection member 40 is provided between the first battery cell 10 and the buffer member 30 located between the first battery cell 10 and the box wall of the box 50. As shown in FIG. 3, the side of the first battery cell 10 facing away from the second battery cell 20 is a battery cell, and the temperature collection member 40 is provided between the first battery cell 10 and the buffer member 30 located between the first battery cell 10 and the second battery cell 20.

In embodiments where the battery 100 includes three and more than three numbers of battery cells and includes a plurality of buffer members 30, one battery cell may be provided between two adjacent buffer members 30, or a plurality of battery cells may be provided. The structures of the plurality of buffer members 30 may or may not be the same. For example, the structure of the buffer member 30 corresponding to the temperature collection member 40 may be different from the buffer members 30 at other locations of the battery 100. FIG. 2 illustrates that the battery 100 includes three and more battery cells and a plurality of buffer members 30 provided in a stacked manner, and one battery cell is provided between two adjacent buffer members 30. In FIG. 3, the battery 100 includes three and more than three numbers of battery cells and a plurality of buffer members 30 provided in a stacked manner, and a plurality of battery cells is provided between two adjacent buffer members 30.

The temperature collection member 40 may be a thermistor, thermocouple, etc. having the negative temperature coefficient (NTC), the positive temperature coefficient (PTC), etc., which is not limited in this application. The number of temperature collection members 40 may be one or a plurality. In the embodiment in which the temperature collection members 40 are a plurality, each temperature collection member 40 is provided between the buffer member 30 and a battery cell located on a side of such buffer member 30 along the stacking direction X. FIGS. 1, 2, and 3 illustrate a case where the battery 100 includes one temperature collection member 40.

The temperature collection member 40 has a sheet structure and is provided between the first battery cell 10 and the buffer member 30, which can reduce the occupied space between the first battery cell 10 and the buffer member 30, reduce the impact on the expansion space of the first battery cell 10, thereby reducing the amount of loss of the expansion space of the first battery cell 10 due to the temperature collection member 40, thereby reducing the risk of the surface of the first battery cell 10 breaking and leaking liquid as well as the risk of causing a short circuit inside the battery in the process of use, and also reducing the impact on the energy density of the battery 100. The temperature collection member 40 having the sheet structure can also accurately characterize the temperature of the battery 100, and improve the reliability of temperature detection. At the same time, the response speed of the temperature collection member 40 having the sheet structure is faster than the response speed of a temperature collection member 40 having a teardrop-shape. Under high rate conditions, the temperature collection member 40 having the sheet structure can quickly respond to the rise in the temperature of the battery 100, and improve the reliability of the use of the battery 100.

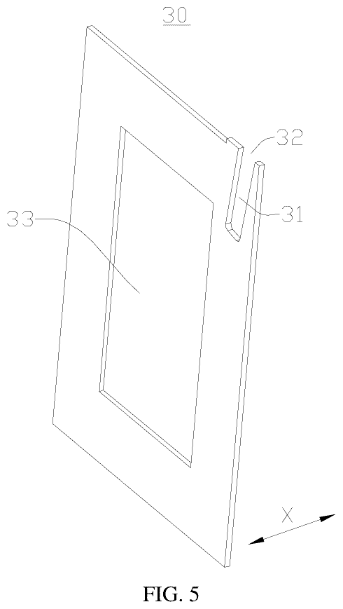

As shown in FIGS. 5 and 6, in some embodiments, the buffer member 30 is provided with an accommodation cavity 31 corresponding to the position of the temperature collection member 40. In some embodiments, the accommodation cavity 31 penetrates through the buffer member 30 along the stacking direction X. In some other embodiments, the accommodation cavity 31 can also be a blind hole extending along the stacking direction X.

As shown in FIG. 5, the accommodation cavity 31 may extend to an edge of the buffer member 30, forming a second opening 32 at the edge of the buffer member 30.

As shown in FIG. 6, the accommodation cavity 31 may be a circumferentially closed hole so that the provision of the accommodation cavity 31 does not affect the structural strength of the buffer member 30.

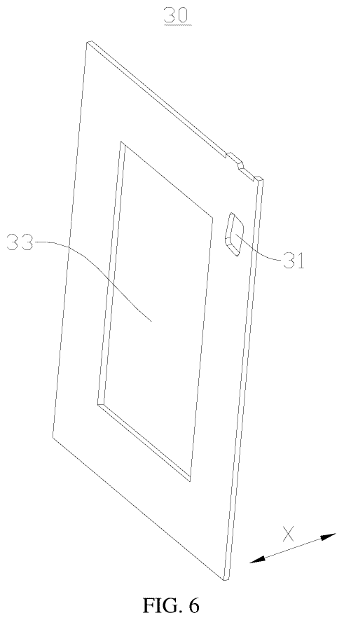

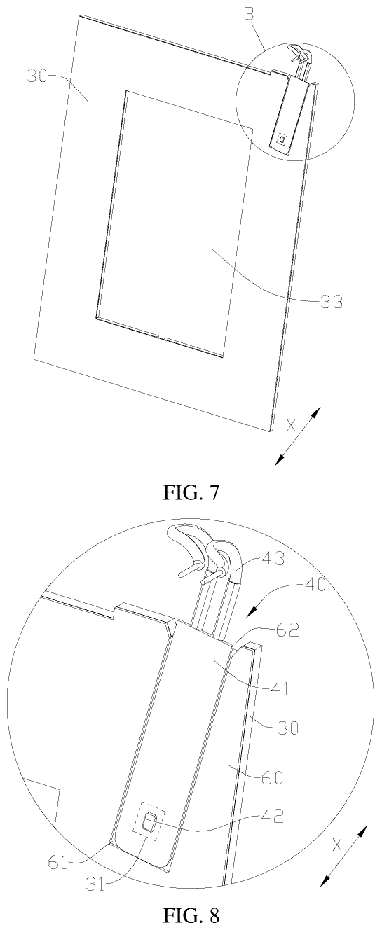

The buffer member 30 is provided with an accommodation cavity 31 corresponding to the position of the temperature collection member 40, and along the stacking direction X, a portion or all of the projection of the temperature collection member 40 on the buffer member 30 is located within the accommodation cavity 31. FIGS. 7 and 8 illustrate a case in which a portion of the projection of the temperature collection member 40 on the buffer member 30 is located within the accommodation cavity 31.

The temperature collection member 40 is provided corresponding to the accommodation cavity 31, so that after the first battery cell 10 expands, the temperature collection member 40 can partially enter the accommodation cavity 31, and the accommodation cavity 31 provides an clearance space for the temperature collection member 40 to avoid the temperature collection member 40 and the buffer member 30 from being extruded, so as to reduce the risk of the temperature collection member 40 being extruded and damaged due to the expansion of the first battery cell 10.

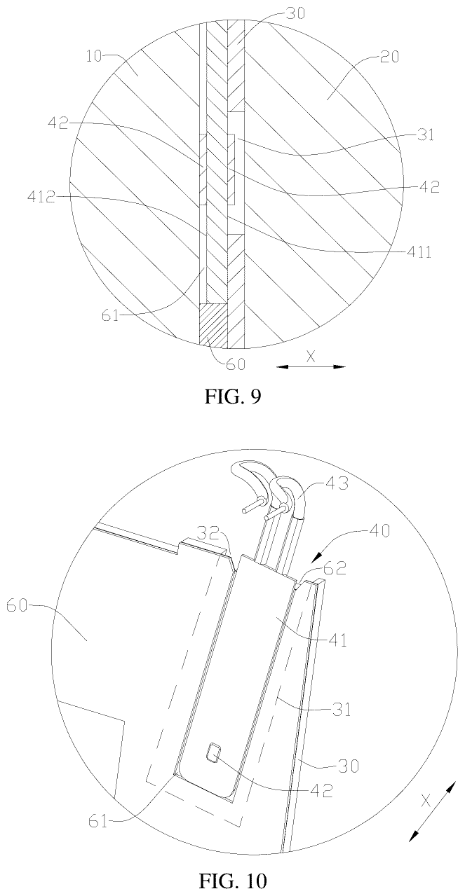

Referring to FIGS. 8 and 9, in some embodiments, the temperature collection member 40 includes a body 41 and two protrusions 42, the two protrusions 42 are formed on two opposite surfaces of the body 41 along the stacking direction X. Along the stacking direction X, among two of the protrusions 42, one protrusion 42 closer to the buffer member 30 has a projection on the buffer member 30 located in the accommodation cavity 31. Among two of the protrusions 42, one protrusion 42 closer to the first battery cell 10 is in contact with the first battery cell 10.

The protrusions 42 are components of the temperature collection member 40 for collecting temperature to enable the temperature collection member 40 to respond to and detect temperature changes in the battery 100.

Two opposite surfaces of the body 41 along the stacking direction X are defined as a first surface 411 and a second surface 412, the first surface 411 is provided facing the buffer member 30, the second surface 412 is provided facing the first battery cell 10, and two protrusions 42 are formed on the first surface 411 and the second surface 412, respectively.

The two protrusions 42 are provided in the body 41 so that along the stacking direction X, projections of the two protrusions 42 overlap on the body 41, either partially or completely. In some other embodiments, along the stacking direction X, projections of the two protrusions 42 on the body 41 may be completely staggered.

Along the stacking direction X, the projection of the protrusion 42 formed on the first surface 411 is located within the accommodation cavity 31 of the buffer member 30, as shown in FIG. 9, so that the protrusion 42 formed on the first surface 411 can be inserted into the accommodation cavity 31 when the first battery cell 10 expands to avoid the protrusion 42 and the buffer member 30 from being extruded. Here, as shown in FIG. 8, a cross-sectional area of the accommodation cavity 31 shall be greater than or equal to a cross-sectional area of the protrusion 42. In some embodiments, the cross-sectional area of the accommodation cavity 31 is greater than the cross-sectional area of the protrusion 42 and less than the cross-sectional area of the body 41, and along the stacking direction X, the projection of the body 41 on the buffer member 30 completely covers the accommodation cavity 31, so that when the first battery cell 10 expands, only the protrusion 42 on the first surface 411 is inserted into the accommodation cavity 31. As shown in FIG. 10, in some other embodiments, along the stacking direction X, the projection of the body 41 on the buffer member 30 may be located within the accommodation cavity 31, then when the first battery cell 10 expands, the body 41 may also enter the accommodation cavity 31 along the stacking direction X, avoiding the body 41 and the buffer member 30 from being extruded, which further reduces the risk of the body of the temperature collection member 40 being extruded and damaged.

The two protrusions 42 respectively form two surfaces of the body 41 opposite to each other along the stacking direction X. The dimension of the temperature collection member 40 at the corresponding position of the protrusion 42 along the stacking direction X is larger than the dimension of the temperature collection member 40 at other positions. When the first battery cell 10 expands, the protrusion 42 on the second surface 412 is the first to be extruded, the projection of the protrusion 42 on the first surface 411 on the buffer member 30 is located in the accommodation cavity 31, and the protrusion 42 closer to the buffer member 30 can be inserted into the accommodation cavity 31 when the first battery cell 10 expands, avoiding the protrusion 42 closer to the buffer member 30 and the buffer member 30 from being extruded, which reduces the risk of the temperature collection member 40 being extruded and damaged.

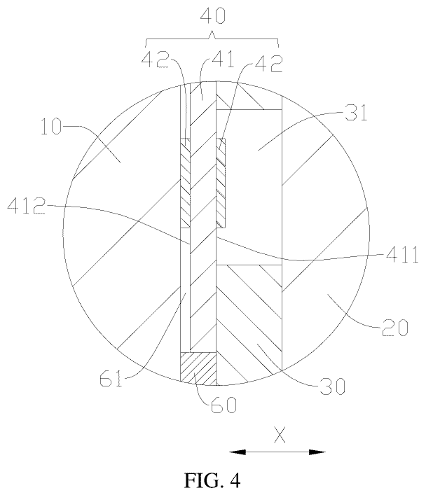

In order to facilitate the installation of the temperature collection member 40 between the buffer member 30 and the first battery cell 10, please refer to FIGS. 4, 11, and 12. In some embodiments, the battery 100 further includes: a mounting plate 60, provided between the first battery cell 10 and the buffer member 30. The mounting plate 60 has a mounting groove 61, the mounting groove 61 penetrates through the mounting plate 60 along a thickness direction of the mounting plate 60. The thickness direction of the mounting plate 60 is in parallel to the stacking direction X, and the temperature collection member 40 is disposed within the mounting groove 61.

The mounting plate 60 may be fixed between the first battery cell 10 and the buffer member 30, such as the mounting plate 60 is fixed to a surface of the buffer member 30 facing the first battery cell 10, or the mounting plate 60 is fixed to the side of the first battery cell 10 facing the buffer member 30. In this embodiment, along the stacking direction X, the mounting plate 60 is provided with a viscose on a surface of the mounting plate 60 facing the first battery cell 10 to enable the mounting plate 60 to be bonded to the surface of the first battery cell 10 facing the buffer member 30. Along the stacking direction X, the surface of the mounting plate 60 facing away from the surface facing the first battery cell 10 may also be provided with a viscose for realizing the bonding of the mounting plate 60 and the buffer member 30 or for realizing the bonding of the mounting plate 60 and the film 70 (shown in FIG. 18).

The mounting groove 61 may be holes that are circumferentially closed and penetrates through the mounting plate 60 along the stacking direction X. As shown in FIG. 11, the mounting groove 61 is a rectangular hole that penetrates through both sides of the mounting plate 60 along the stacking direction X, so that the mounting groove 61 is provided in a manner that does not affect the structural strength of the buffer member 30.

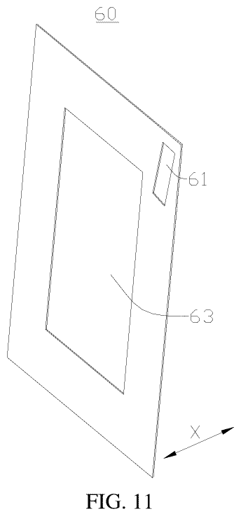

In some embodiments, the mounting groove 61 may also be in other structural forms. For example, as shown in FIG. 12, in some embodiments, the mounting groove 61 forms a first opening 62 at an edge of the mounting plate 60 to allow the temperature collection member 40 to be inserted into the mounting groove 61 through the first opening 62.

In some embodiments, an end of the mounting groove 61 extends to an edge of the mounting plate 60 and penetrates through that edge of the mounting plate 60 to form a first opening 62 through which the temperature collection member 40 can be inserted into the mounting groove 61, facilitating installation of the temperature collection member 40 into the mounting groove 61.

The temperature collection member 40 is provided in the mounting groove 61, and the protrusion 42 formed on the second surface 412 extends out of the mounting groove 61 along the stacking direction X, or the surface of the protrusion 42 formed on the second surface 412 facing the first battery cell 10 is flush with the surface of the mounting plate 60 facing the first battery cell 10, so that the protrusion 42 formed on the second surface 412 can come into contact with the first battery cell 10, thereby realizing temperature collection of the first battery cell 10. The protrusion 42 formed on the second surface may extend out of the mounting groove 61 along the stacking direction X. The protrusion 42 formed on the second surface 412 may also be located within the mounting groove 61 in the stacking direction X.

The mounting plate 60 is provided to facilitate the installation of the temperature collection member 40, and the temperature collection member 40 is installed in the mounting groove 61 of the mounting plate 60, avoiding the temperature collection member 40 and the mounting plate 60 from occupying too much space between the first battery cell 10 and the buffer member 30, and reduces the impact on the energy density of the battery 100.

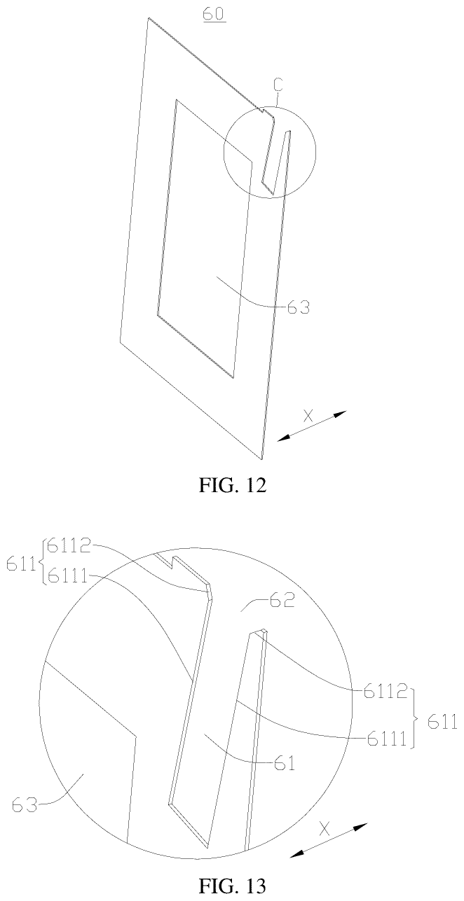

To facilitate the insertion of the temperature collection member 40 from the first opening 62, referring to FIG. 13, a guiding bevel 6112 is provided at an end of the mounting groove 61 closer to the first opening 62, and the guiding bevel 6112 is used to guide the temperature collection member 40 to be inserted into the mounting groove 61.

The mounting groove 61 has two groove walls 611 opposite each other, each groove wall 611 including a flat surface 6111 and a guiding bevel 6112, an end of the guiding bevel 6112 being connected to the flat surface 6111, and an end of the guiding bevel 6112 facing away from the flat surface 6111 extending to an edge of the mounting plate 60. The flat surfaces 6111 of the two groove walls 611 are arranged parallel to each other, the guiding bevels 6112 are arranged at an angle with respect to the flat surfaces 6111, and a distance between an end of the guiding bevels 6112 of the two groove walls 611 that is connected to the flat surfaces 6111 is less than a distance between an end of the guiding bevels 6112 of the two groove walls 611 facing away from the flat surfaces 6111, so that the distance between the two groove walls 611 at the first opening 62 is greater than the distance between the two groove walls 611 at other locations.

In some other embodiments, both groove walls 611 may also be flat surfaces 6111 arranged in parallel, so that both groove walls 611 are the same distance apart at any position.

The guiding bevel 6112 is provided at an end of the mounting groove 61 closer to an edge of the mounting plate 60 to enable the mounting groove 61 to form a larger first opening 62 at the edge of the mounting plate 60, so that the temperature collection member 40 can be smoothly mounted into the mounting groove 61.

In some embodiments, a hardness of the mounting plate 60 is greater than a hardness of the buffer member 30.

In this embodiment, the hardness of the mounting plate 60 is greater than the hardness of the buffer member 30, wherein the mounting plate 60 may be a rigid plate.

In some embodiments, the mounting plate 60 is an incompressible plate, and the mounting plate 60 is not compressed when subjected to extrusion along the stacking direction X. The mounting plate 60 may be a polycarbonate (PC) plate, a wood plate, etc.

In some other embodiments, the material of the mounting plate 60 may be a compressible material, and in a case where the hardness of the mounting plate 60 is greater than the hardness of the buffer member 30, the amount of compression of the mounting plate 60 along the stacking direction X is less than the amount of compression of the buffer member 30 along the stacking direction X when the first battery cell 10 expands under the condition of the same extruding force.

The hardness of the mounting plate 60 is greater than the hardness of the buffer member 30, which can not only provide a stable support for the temperature collection member 40 mounted on the mounting plate 60, but also reduce the degree of compression of the mounting plate 60 when the first battery cell 10 expands, or avoid the mounting plate 60 from being compressed when the first battery cell 10 expands.

In some embodiments, the mounting plate 60 is an insulating material, which can reduce the risk of short circuit inside the battery 100.

In some other embodiments, the material of the mounting plate 60 may also be a conductor or a semiconductor material, depending on practical needs while ensuring that the short circuit inside the battery 100 will not be caused by the mounting plate 60.

The expansion of the battery cell is not even, and for the first battery cell 10, a side of the first battery cell 10 facing the buffer member 30 has a central expansion region and a peripheral expansion region, and the peripheral expansion region surrounds the central expansion region, and the expansion amount of the central expansion region along the stacking direction X is greater than the expansion amount of the peripheral expansion region in the stacking direction X. Then the portions of the mounting plate 60 and the buffer member 30 that are opposite to the central expansion region are extruded more severely relative to the portions of the mounting plate 60 and the buffer member 30 that are opposite to the peripheral expansion region.

Based on this, please continue to refer to FIGS. 11 and 12, in some embodiments, the mounting plate 60 is provided with a first through hole 63, along the stacking direction, the first through hole 63 penetrates through the mounting plate 60.

The first through hole 63 is provided at the center of the mounting plate 60, and the first through hole 63 is provided corresponding to the central expansion region on a side of the first battery cell 10 facing the buffer member 30, and when the central expansion region expands, the first through hole 63 allows the central expansion region to expand within the first through hole 63 along the stacking direction X. The first through hole 63 may be an oval hole, a rectangular hole, a circular hole, etc., and the first through hole 63 is shown as a rectangular hole in FIGS. 11 and 12.

The first through hole 63 is provided at the center of the mounting plate 60, which can avoid the central expansion region of the first battery cell 10, avoid the loss of the expansion space of the first battery cell 10 due to the provision of the mounting plate 60, and effectively reduce the risk of the surface of the first battery cell 10 breaking and leaking liquid caused by the mounting plate 60 interfering with the expansion of the first battery cell 10.

Referring to FIGS. 6, 7, and 14, in some embodiments, the buffer member 30 is provided with a second through hole 33, along the stacking direction X, the second through hole 33 penetrating through the buffer member 30. A projection of the first through hole 63 on the buffer member 30 at least partially overlaps the second through hole 33.

The second through hole 33 is provided corresponding to the central expansion region on a side of the first battery cell 10 facing the buffer member 30, and when the central expansion region expands, the second through hole 33 allows the central expansion region to expand within the second through hole 33 along the stacking direction X.

In some embodiments, along the stacking direction X, the contour of the projection of the first through hole 63 on the buffer member 30 overlaps the contour of the second through hole 33 so that the projection of the first through hole 63 on the buffer member 30 completely overlaps the second through hole 33. In some other embodiments, along the stacking direction X, the projection of the first through hole 63 on the buffer member 30 may be located within the second through hole 33, and the contour of the second through hole 33 is disposed around the outer periphery of the contour of the projection of the first through hole 63 on the buffer member 30 so that a portion of the second through hole 33 overlaps the projection of the first through hole 63 on the buffer member 30. In still other embodiments, along the stacking direction X, the second through hole 33 is located within the projection of the first through hole 63 on the buffer member 30, the contour of the projection of the first through hole 63 on the buffer member 30 is disposed around the periphery of the contour of the second through hole 33 so that a portion of the projection of the first through hole 63 on the buffer member 30 overlaps the second through hole 33.

Of course, in some other embodiments, along the stacking direction X, the projection of the first through hole 63 on the buffer member 30 partially overlaps the first through hole 63.

The second through hole 33 may be an oval hole, a rectangular hole, a circular hole, etc., and the second through hole 33 is shown as a rectangular hole in FIGS. 6, 7, and 14.

The second through hole 33 is provided at the center of the buffer member 30, and the projection of the first through hole 63 of the mounting plate 60 on the buffer member 30 overlaps the second through hole 33, which can avoid the central expansion region of the first battery cell 10, avoid the loss of the expansion space of the first battery cell 10 due to the provision of the mounting plate 60 and the buffer member 30, and effectively reduce the risk of the surface of the first battery cell 10 breaking and leaking liquid caused by the mounting plate 60 and the buffer member 30 interfering with the expansion of the first battery cell 10.

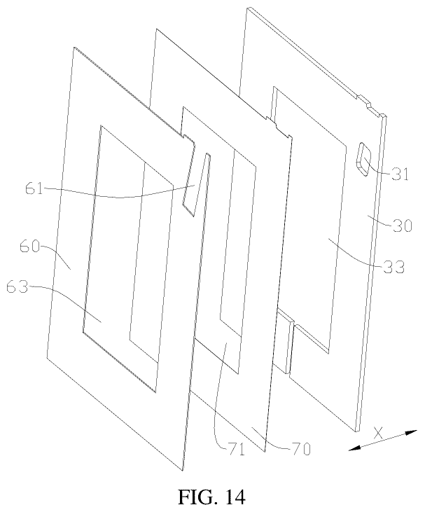

As shown in FIG. 15, in some embodiments, the temperature collection member 40 has a maximum thickness of h1 and the mounting plate 60 has a thickness of h2, satisfying: h2<h1.

The maximum thickness h1 of the temperature collection member 40 is a distance between a surface of the temperature collection member 40 that is closest to the first battery cell 10 and a surface of the temperature collection member 40 that is furthest away from the first battery cell 10, along the stacking direction X. In this embodiment, the maximum thickness h1 of the temperature collection member 40 is a distance between a surface of the protrusion 42 forming the first surface 411 backing from the first surface 411 and a surface of the protrusion 42 forming the second surface 412 backing from the second surface 412.

In this embodiment, the mounting plate 60 is an equal-thickness plate, and the mounting plate 60 has the same thickness at any location. In some other embodiments, the mounting plate 60 is a non-equal thickness plate, and the thickness h2 of the mounting plate 60 is a maximum thickness of the mounting plate 60.

The maximum thickness of the temperature collection member 40 is greater than the thickness of the mounting plate 60, so that after the temperature collection member 40 is mounted in the mounting groove 61, the temperature collection member 40 can extend out of the mounting groove 61 along the stacking direction X to enable the temperature collection member 40 to be in contact with the first battery cell 10, so as to make the collected temperature information more accurate. In this embodiment, the two protrusions 42 of the temperature collection member 40 extend out of the mounting groove 61 in directions facing away from each other.

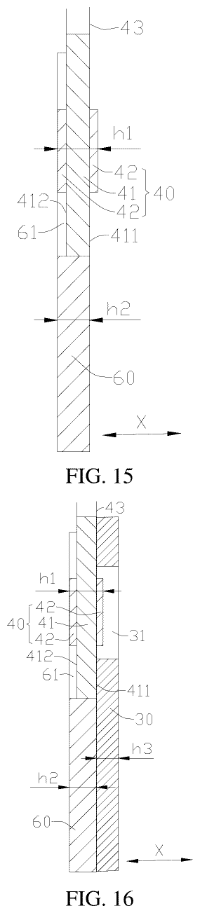

As shown in FIG. 16, in some embodiments, the temperature collection member 40 has a maximum thickness of h1, the mounting plate 60 has a thickness of h2, and the buffer member 30 compressed to a limit has a thickness of h3, satisfying: h2+h3≥ h1.

The buffer member 30 is compressed to a limit, meaning a state in which the buffer member 30 reaches a compression limit and the thickness of the buffer member 30 does not continue to decrease as the first battery cell 10 expands further along the stacking direction X.

The sum of the thickness of the mounting plate 60 and the thickness of the buffer member 30 compressed to the limit is greater than or equal to the maximum thickness of the temperature collection member 40, so that even when the buffer member 30 is compressed to the limit state, the temperature collection member 40 is not be extruded, and the risk of the temperature collection member 40 being extruded and damaged is reduced.

In order to accurately obtain a temperature of the first battery cell 10, it is necessary to maintain the temperature collection member 40 in contact with the first battery cell 10. When the temperature collection member 40 is inserted in the mounting groove 61, during the expansion of the first battery cell 10, the first battery cell 10 may drive the temperature collection member 40 to move in the mounting groove 61 along stacking direction X towards the buffer member 30, and there occurs a state in which the temperature collection member 40 is not in contact with the first battery cell 10, resulting in the collected temperature information not characterizing the true temperature of the first battery cell 10.

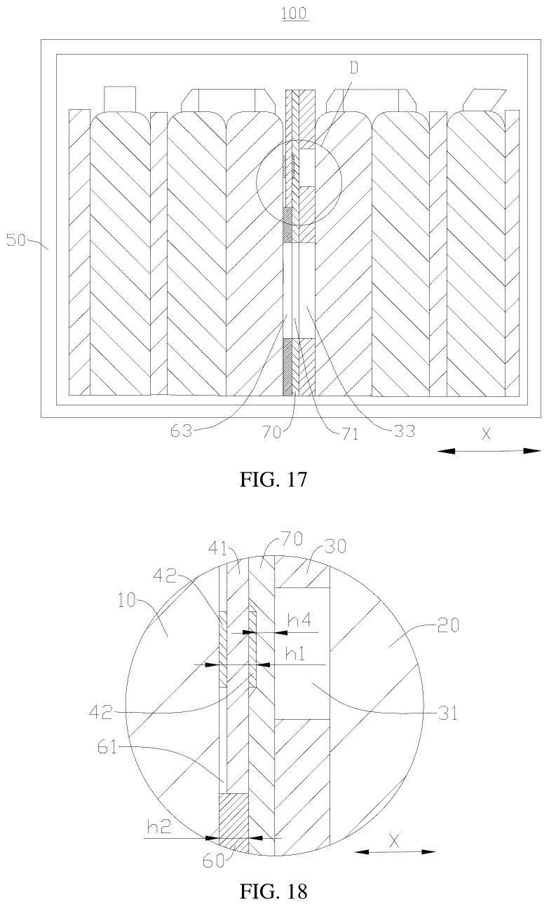

Based on this, as shown in FIGS. 17 and 18, in some embodiments, the battery 100 further includes: a film 70, provided between the mounting plate 60 and the buffer member 30. The film 70 at least partially covers the temperature collection member 40.

The film 70 is made of a thin, lightweight material that is flexible and elastic. The film 70 may be made of a polyimide film (PI film) or other materials.

In these embodiments, the film 70 is secured to a side of the mounting plate 60 facing away from the first battery cell 10 and covers the temperature collection member 40, and the film 70 may cover a portion or all of the temperature collection member 40 so that the temperature collection member 40 can always be in contact with the first battery cell 10.

When the first battery cell 10 expands and drives the temperature collection member 40 to move in the mounting groove 61 along the stacking direction X toward the buffer member 30, the film 70 is stretched by the temperature collection member 40 to undergo elastic deformation and resist rebound. Driven by the elastic force of the film 70, the temperature collection member 40 moves along the stacking direction X toward the first battery cell 10 and always maintains contact with the first battery cell 10.

The film 70 has a thickness of h4, the temperature collection member 40 has a maximum thickness of h1, the mounting plate 60 has a thickness of h2, and the buffer member 30 compressed to a limit has a thickness of h3, satisfying: h2+h3+h4≥h1+h4.

In some embodiments, the film 70 is provided with a third through hole 71. Along the stacking direction X, the third through hole 71 penetrates through the film 70, and the projections of the first through hole 63 and the second through hole 33 on the film 70 overlaps the third through hole 71.

The third through hole 71 is provided corresponding to the central expansion region on a side of the first battery cell 10 facing the buffer member 30, and when the central expansion region expands, the third through hole 71 allows the central expansion region to expand within the third through hole 71 along the stacking direction X.

In some embodiments, along the stacking direction X, the contour of the projection of the first through hole 63 on the film 70 and the contour of the projection of the second through hole 33 on the film 70 overlap the contour of the third through hole 71 so that the projection of the first through hole 63 on the film 70 and the projection of the second through hole 33 on the film 70 overlap completely with the third through hole 71. In some other embodiments, along the stacking direction X, the projection of the first through hole 63 on the film 70 and the projection of the second through hole 33 on the film 70 may be located within the third through hole 71, the contour of the third through hole 71 is disposed around the outer periphery of the contour of the projection of the first through hole 63 on the film 70 and around the outer periphery of the contour of the projection of the second through hole 33 on the film 70, so that a portion of the third through hole 71 overlaps the projection of the first through hole 63 on the film 70 and the projection of the second through hole 33 on the film 70. In some other embodiments, along the stacking direction X, the third through hole 71 is located within the projection of the first through hole 63 on the film 70 and the projection of the second through hole 33 on the film 70, and the contour of the projection of the first through hole 63 on the film 70 and the contour of the projection of the second through hole 33 on the film 70 are disposed around the periphery of the contour of the third through hole 71, and a portion of the projection of the first through hole 63 on the film 70 and a portion of the projection of the second through hole 33 on the film 70 overlap the third through hole 71.

The film 70 is provided between the buffer member 30 and the mounting plate 60 and covers at least the temperature collection member 40, so that the film 70 can enable the temperature collection member 40 to always remain in contact with the first battery cell 10, which is conducive to the temperature collection member 40 to obtain accurate temperature information.

The film 70 is secured to the mounting plate 60 by a plurality of means, for example, in some embodiments, the film 70 is bonded or heat fused to the mounting plate 60. Connecting the film 70 to the mounting plate 60 by means of bonding or heat fusion is a convenient way of connecting and does not increase the thickness of the overall structure after the film 70 and the mounting plate 60 are connected.

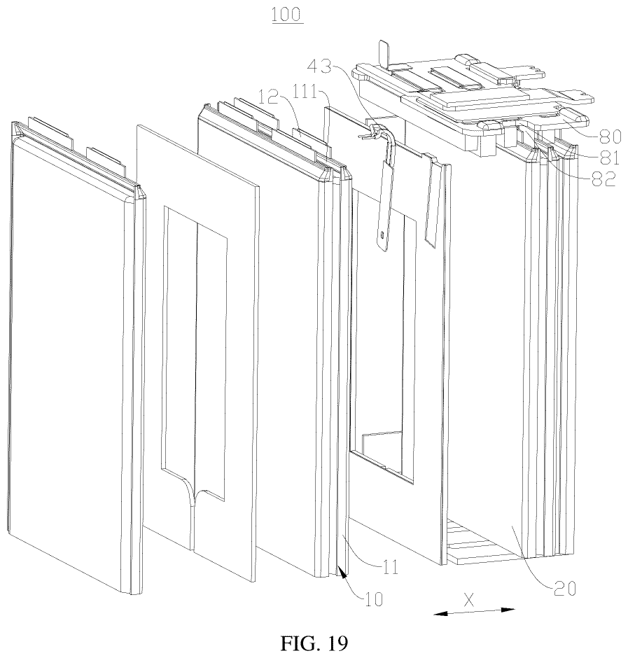

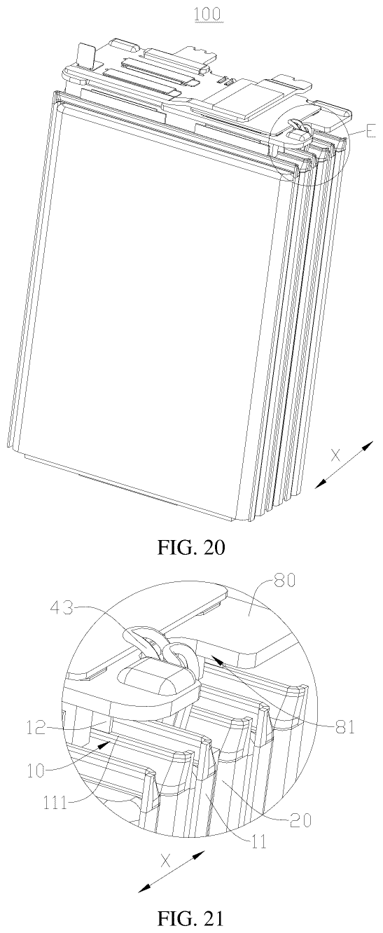

As shown in FIGS. 19, 20, and 21, in some embodiments, the battery 100 further includes: a circuit board 80 and a wire 43. The circuit board 80 is provided on a side of the first battery cell 10 and the second battery cell 20 along a first direction, the first direction is perpendicular to the stacking direction X; one end of the wire 43 is connected to the temperature collection member 40, and the other end of the wire 43 is connected to a side of the circuit board 80 facing away from the first battery cell 10 and the second battery cell 20; where the circuit board 80 is provided with a channel 81, the channel 81 penetrates through the circuit board 80 in a thickness direction of the circuit board 80, and the channel 81 is configured for passage of the wire 43.

In these embodiments, the channel 81 extends to an edge of the circuit board 80 so that the channel 81 forms a third opening 82 at the edge of the circuit board 80, facilitating the entry of the wire 43 into the channel 81 through the third opening 82. In some other embodiments, the channel 81 may also be circumferentially closed in a hole structure.

In these embodiments, the first direction is perpendicular to the stacking direction X. The first battery cell 10 includes a battery cell body 11 and a tab 12, the tab 12 extending from an end portion 111 of the battery cell body 11. The tab 12 of the first battery cell 10 may be electrically connected to the circuit board 80, and the circuit board 80 is arranged close to the tab 12 and opposite to the end portion 111. For a jelly-roll battery cell, the first direction is parallel to the winding axis direction, and the circuit board 80 is disposed at an end of the winding axis direction. For a stacked battery cell, the first direction is perpendicular to the stacking direction of electrode plates of the battery cell and the tab 12 extends from the battery cell body 11 along the first direction, and the circuit board 80 is located at an end of the first battery cell 10 along the first direction.

The circuit board 80 is provided with a channel 81 for the wire 43 to pass through, the wire 43 serves as a soldered jumper wire, and the wire 43 passes through the channel 81 and are connected to the side of the circuit board 80 back away from the first battery cell 10 and the second battery cell 20, which can avoid the temperature collection member 40 of the sheet structure from being bent in the assembling process resulting in damage to the phosphor bronze frame of the temperature collection member 40, and can also reduce the extension path of the wire 43, reducing the length of the wire 43, thereby reducing the occupied internal space of the battery 100 by the wire 43.

In some embodiments, along the thickness direction of the circuit board 80, the projection of the temperature collection member 40 on the circuit board 80 at least partially overlaps the channel 81.

In these embodiments, along the thickness direction of the circuit board 80, the projection of the temperature collection member 40 on the circuit board 80 is located within the channel 81 so that the projection of the temperature collection member 40 on the circuit board 80 completely overlaps the channel 81. In some other embodiments, along the thickness direction of the circuit board 80, the projection of the temperature collection member 40 on the circuit board 80 is partially located within the channel 81 so that the projection of the temperature collection member 40 on the circuit board 80 partially overlaps the channel 81.

In these embodiments, the first opening 62 of the mounting groove 61 is provided facing the channel 81, and along the thickness direction of the circuit board 80, the projection of the mounting groove 61 on the circuit board 80 is located within the channel 81, so that after the installation of the circuit board 80, the mounting plate 60, the buffer member 30, and the film 70 is complete, the temperature collection member 40 can be inserted into the mounting groove 61 through the channel 81 and the first opening 62 of the mounting groove 61, in sequence, facilitating installation of the temperature collection member 40.

The projection of the temperature collection member 40 on the circuit board 80 at least partially overlaps the channel 81 so that the temperature collection member 40 can be inserted between the first battery cell 10 and the buffer member 30 from the position of the channel 81, facilitating the installation of the temperature collection member 40.

In some embodiments, the first battery cell 10 includes a battery cell body 11 and a tab 12 extending from an end portion 111 of the battery cell body 11, and the temperature collection member 40 is provided at the end portion 111.

The temperature collection member 40 is provided at the end portion 111, meaning that the temperature collection member 40 is provided between the first battery cell 10 and the buffer member 30 and is provided close to the tab 12. The region close to the tab 12 belongs to the peripheral expansion region where the expansion amount of the first battery cell 10 is smaller. For the first battery cell 10, the temperature at the tab 12 is generally higher than the temperature of the battery cell body 11 due to the current flowing through the tab 12, and therefore the temperature of the region close to the tab 12 of the first battery cell 10 better characterizes the true temperature of the first battery cell 10.

Therefore, the temperature collection member 40 is provided at the end portion 111, thus the temperature collection member 40 is provided close to the tab 12, which not only enables the temperature collection member 40 to be provided in a region corresponding to a region where the expansion amount of the first battery cell 10 is smaller, reduces the risk of the temperature collection member 40 being extruded and damaged, but also enables the temperature collection member 40 to collect more accurate temperature information.

An embodiment of this application further provides an electrical device. The electrical device includes an electrical body 41 and a battery 100 provided in any of the above embodiments, the battery 100 is used to power the electrical body 41.

The temperature collection member 40 of the battery 100 of any of the above embodiments has a sheet structure, and is provided between the first battery cell 10 and the buffer member 30, which can reduce the occupied space between the first battery cell 10 and the buffer member 30, and reduce the impact on the energy density of the battery 100. The temperature collection member 40 having the sheet structure can also accurately characterize the temperature of the battery 100, and improve the reliability of temperature detection. At the same time, the response speed of the temperature collection member 40 having the sheet structure is faster than the response speed of a temperature collection member 40 having a teardrop-shape. Under high rate conditions, the temperature collection member 40 having the sheet structure can quickly respond to the temperature rise of the battery 100, improving the reliability of the use of the battery 100 of the electrical device.

The above is only a preferred embodiment of this application, and is not intended to limit this application, and this application is subject to various changes and variations for a person skilled in the art. Any modifications, equivalent substitutions, and improvements made without departing from the spirit and principles of this application still fall within the protection scope of this application.

What is claimed is:

1. A battery, comprising:
a first battery cell and a second battery cell stacked together;
a buffer member, provided between the first battery cell and the second battery cell and/or provided on a side of the first battery cell facing away from the second battery cell; and
a temperature collection member, provided between the first battery cell and the buffer member, for collecting a temperature of the first battery cell;
wherein the temperature collection member has a sheet structure, a thickness direction of the temperature collection member is parallel to a stacking direction of the first battery cell and the second battery cell.

2. The battery according to claim 1, wherein the buffer member is provided with an accommodation cavity;
the temperature collection member comprises a body and two protrusions, the two protrusions are formed on two surfaces of the body opposite to each other along the stacking direction; and along the stacking direction, among the two protrusions, one protrusion closer to the buffer member has a projection on the buffer member located in the accommodation cavity.

3. The battery according to claim 2, wherein the projection of the one protrusion along the stacking direction and a projection of the other of the two protrusions along the stacking direction overlap on the body; a dimension of the temperature collection member along the stacking direction at the corresponding position of the two protrusions is larger than the dimension of the temperature collection member at other positions.

4. The battery according to claim 3, wherein the battery further comprises:
a mounting plate, provided between the first battery cell and the buffer member; the mounting plate comprising a mounting groove, the mounting groove penetrating through the mounting plate in a thickness direction of the mounting plate, a thickness direction of the mounting plate being parallel to the stacking direction, and the temperature collection member being provided in the mounting groove.

5. The battery according to claim 4, wherein the mounting groove forms a first opening at an edge of the mounting plate, and the temperature collection member is inserted into the mounting groove through the first opening.

6. The battery according to claim 4, wherein a hardness of the mounting plate is greater than a hardness of the buffer member.

7. The battery according to claim 4, wherein a central area of the mounting plate is provided with a first through hole; along the stacking direction, the first through hole penetrates through the mounting plate.

8. The battery according to claim 7, wherein the buffer member is provided with a second through hole; along the stacking direction, the second through hole penetrates through the buffer member, and a projection of the first through hole on the buffer member at least partially overlaps the second through hole.

9. The battery according to claim 4, wherein the temperature collection member has a maximum thickness of h1 and the mounting plate has a thickness of h2, and h2<h1.

10. The battery according to claim 9, wherein the temperature collection member has a maximum thickness of h1, the mounting plate has a thickness of h2, and the buffer member has a thickness of h3, wherein h2+h3≥h1.

11. The battery according to claim 8, wherein the battery further comprises a film, provided between the mounting plate and the buffer member, the film at least partially covering the temperature collection member.

12. The battery according to claim 11, wherein the film covers the one protrusion closer to the buffer member, the other protrusion of the two protrusions is in contact with the first battery cell.

13. The battery according to claim 12, wherein the film is bonded to the mounting plate.

14. The battery according to claim 12, wherein the film is provided with a third through hole; along the stacking direction, the third through hole penetrates through the film, a projection of the first through hole on the film and a projection of the second through hole on the film are both at least partially overlapped with the third through hole.

15. The battery according to claim 1, wherein the battery further comprises:
a circuit board, provided on a side of the first battery cell and the second battery cell along a first direction, the first direction being perpendicular to the stacking direction; and
a wire, one end of the wire being connected to the temperature collection member and the other end of the wire being connected to a side of the circuit board facing away from the first battery cell and the second battery cell;
wherein the circuit board is provided with a channel, the channel penetrates through the circuit board in a thickness direction of the circuit board, and the wire passes through the channel.

16. The battery according to claim 14, wherein, along the thickness direction of the circuit board, a projection of the temperature collection member on the circuit board at least partially overlaps the channel.

17. The battery according to claim 1, wherein the first battery cell comprises a battery cell body and a tab extending from an end portion of the battery cell body, the temperature collection member is provided at the end portion.

18. The battery according to claim 1, wherein the first battery cell is a pouch battery cell.

19. The battery according to claim 1, wherein the buffer member includes a foam.

20. An electrical device comprising the battery according to claim 1.
